(19) United States
(12) Patent Application Publication
(10) Pub. No.: US 2021/0003414 A1
(43) Pub. Date: Jan. 7, 2021

(54) IMAGE CONTROL APPARATUS, DISPLAY APPARATUS, MOVABLE BODY, AND IMAGE CONTROL METHOD

(71) Applicants: Hiroshi YAMAGUCHI, Tokyo (JP); Kenichiroh SAISHO, Tokyo (JP); Masato KUSANAGI, Tokyo (JP); Yuuki SUZUKI, Tokyo (JP); Keita KATAGIRI, Tokyo (JP)

(72) Inventors: Hiroshi YAMAGUCHI, Kanagawa (JP); Kenichiroh SAISHO, Tokyo (JP); Masato KUSANAGI, Kanagawa (JP); Yuuki SUZUKI, Kanagawa (JP); Keita KATAGIRI, Kanagawa (JP)

(21) Appl. No.: 16/982,788

(22) PCT Filed: Mar. 28, 2019
(86) PCT No.: PCT/JP2019/013700

§ 371 Date: Sep. 21, 2020

(30) Foreign Application Priority Data
Mar. 29, 2018 (JP) 2018-063761
Mar. 12, 2019 (JP) 2019-045258

(51) Int. Cl. G01C 21/36; G09G 5/38; B60K 35/00

(52) U.S. Cl. CPC G01C 21/365; G09G 5/38; B60K 35/00; G09G 2380/10; G02B 27/0101; B60K 2370/166; B60K 2370/1529; B60K 2370/334; B60K 2370/18

(57) ABSTRACT

An image control apparatus installed in a movable body, includes a controller to generate data of an image to be displayed so as to appear to be superimposed on a predetermined position including at least a road surface in a direction along which the movable body moves, as viewed from an occupant of the movable body. The controller generates a pattern to be displayed at the predetermined position, upon detecting that a change in a route is included in a planned path that is generated in advance, and that a change position of the route is further away than the predetermined position as viewed from the occupant, and the pattern is displayed in such a manner that an actual position of the change position of the route appears to be positioned on an extended line of at least part of information forming the pattern, as viewed from the occupant.

### TECHNICAL FIELD

The present invention relates to an image control apparatus, a display apparatus, a movable body, and an image control method.

### BACKGROUND ART

Development of a head-up display (HUD) installed in a movable body such as a vehicle, a ship, an aircraft, and an industrial robot, etc., is in progress. The HUD directly projects information to a person's field of view, and provides the occupant with various kinds of information. In the HUD, the generated light image is diffracted in a direction toward the occupant by the windshield or a combiner, etc., and is displayed as if the image exists at a virtual image position in front of the occupant's line of sight. The image is displayed in a superimposed manner on the travelling path ahead at the virtual image position (see, for example, Patent Literature 1).

There is known a HUD device that generates, as an image to be displayed in a superimposed manner, route information indicating the route along which the own vehicle is scheduled to move, and that displays the route information in a superimposed manner on the road surface ahead. There is proposed a method to be performed in a case where curve information is included in the route information, but the curve information does not fit in a predetermined display area. In such a case, by the proposed method, the curve information is shifted so that at least a part of the curve information is included in the display area (see, for example, Patent Literature 2).

### CITATION LIST

### Patent Literature

PTL 1: Japanese Laid-Open Patent Application No. 2016-145783

PTL 2: Japanese Laid-Open Patent Application No. 2017-211370

### SUMMARY OF INVENTION

### Technical Problem

FIGS. 1A and 1B are diagrams for describing a known method of shifting route change information. In the known method, as illustrated in FIG. 1A, the route where the movable body is to turn is near, and a correction is made when the image of the route information would become outside the display area from the front, that is, below the display area from the driver's viewpoint. As illustrated in FIG. 1B, the marks M1 to M7 of the route information that are initially supposed to be displayed, are controlled to be shifted to the positions of M1s to M7s that are upper positions from the driver's viewpoint, so that at least some of the marks M1s to M7s after being shifted fit in the display area.

In this method, after the curve information is generated, it is determined whether the curve information fits in the display area, and when it is determined that the curve information does not fit in the display area, the curve information is shifted so as to fit in the display area. This determination is made immediately before the route is changed (that is, for example, immediately before a position where a left turn or a right turn is to be taken, etc.), and, therefore, it is difficult for the driver to recognize the change in the route, and it is difficult to recognize the driving situation with enough time.

Furthermore, in general, when displaying a curve, etc., in a path image, the path image representing a curve is displayed in a state where the curve of an actual road exists in the display area. Therefore, in this case also, it is difficult to recognize the driving situation with enough time.

The present disclosure has an object to display the change of the route in a manner that can be easily recognized by an occupant of a movable body, when the route information including a change in the route is displayed in a superimposed manner on the surrounding environment.

### Solution to Problem

An aspect of the present invention provides an image control apparatus installed in a movable body, the image control apparatus including a controller configured to generate data of an image to be displayed so as to appear to be superimposed on a predetermined position including at least a road surface in a direction along which the movable body moves, as viewed from an occupant of the movable body, wherein the controller generates a pattern to be displayed at the predetermined position, upon detecting that a change in a route is included in a planned path that is generated in advance, and that a change position where the route changes is further away than the predetermined position as viewed from the occupant of the movable body, and the pattern is displayed in such a manner that an actual position of the change position in reality appears to be positioned on an extended line of at least part of information forming the pattern, as viewed from the occupant.

### Advantageous Effects of Invention

According to the present disclosure, it is possible to display the change of the route in a manner that can be easily recognized by an occupant of a movable body, when the route information including a change in the route is displayed in a superimposed manner on the surrounding environment.

### BRIEF DESCRIPTION OF DRAWINGS

FIG. 1A is a diagram for describing a conventional method of shifting route change information.

FIG. 1B is a diagram for describing a conventional method of shifting route change information.

FIG. 2 is a schematic view illustrating an automobile equipped with a HUD, as an example of a movable body equipped with a display apparatus according to an embodiment of the present invention.

FIG. 3 is a view illustrating an example of arrangement of a projection area according to an embodiment of the present invention.

FIG. 4 is a hardware configuration diagram of a display apparatus according to an embodiment of the present invention.

FIG. 5 is a schematic view illustrating a connection relationship between the display apparatus and other electronic devices installed in the movable body according to an embodiment of the present invention.

FIG. 6 is a functional block diagram of an image control apparatus of the display apparatus according to an embodiment of the present invention.

FIG. 7 is a diagram illustrating an example of path guidance information indicating a route change according to an embodiment of the present invention.

FIG. 8 is a diagram illustrating another example of path guidance information indicating a route change according to an embodiment of the present invention.

FIG. 9A is a diagram illustrating yet another example of path guidance information indicating a route change according to an embodiment of the present invention.

FIG. 9B is a diagram illustrating yet another example of path guidance information indicating a route change according to an embodiment of the present invention.

FIG. 10A is a diagram illustrating yet another example of path guidance information indicating a route change according to an embodiment of the present invention.

FIG. 10B is a diagram illustrating yet another example of path guidance information indicating a route change according to an embodiment of the present invention.

FIG. 11A is a diagram illustrating yet another example of path guidance information indicating a route change according to an embodiment of the present invention.

FIG. 11B is a diagram illustrating yet another example of path guidance information indicating a route change according to an embodiment of the present invention.

FIG. 12 is a flowchart of a display control method according to an embodiment of the present invention.

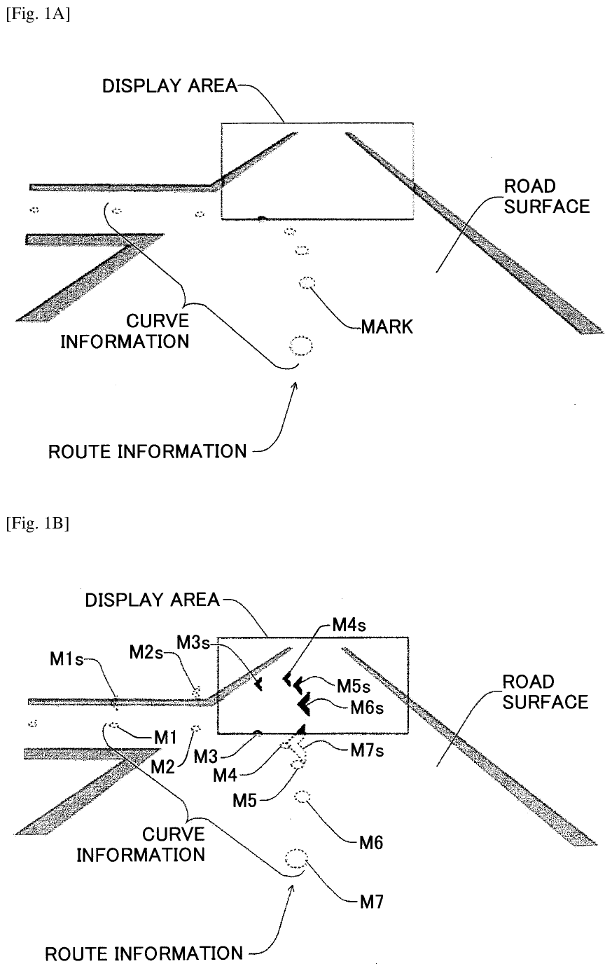

### DESCRIPTION OF EMBODIMENTS

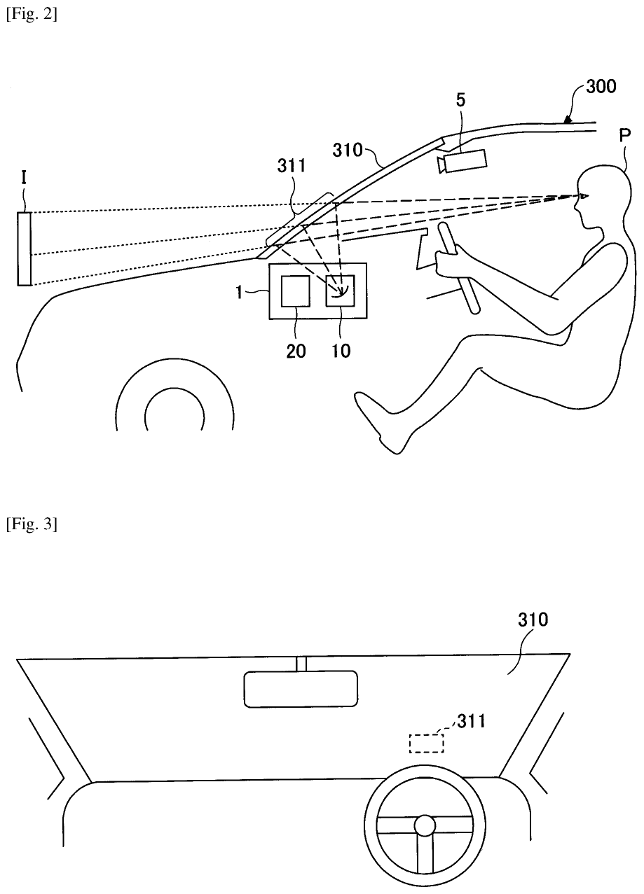

FIG. 2 schematically illustrates an automobile 300 as an example of a movable body in which a display apparatus 1 is installed. The display apparatus 1 is an on-vehicle head-up display (hereinafter, abbreviated as “HUD”) in this example. The movable body in which the display apparatus 1 is installed is not limited to the automobile 300, and the display apparatus 1 can be installed in a movable body such as a vehicle, a ship, an aircraft, or an industrial robot. The automobile 300 may have a function of adaptive cruise control (ACC: semi-automatic traveling).

The display apparatus 1 is set, for example, on the dashboard or in the dashboard of the automobile 300, and the display apparatus 1 projects a light image to a predetermined projection area 311 of a windshield 310 in front of the driver or passenger (hereinafter simply referred to as “occupant”) P.

The display apparatus 1 includes an optical apparatus 10 and an image control apparatus 20. The image control apparatus 20 mainly generates data of an image to be projected onto the windshield 310 and controls the display. The optical apparatus 10 projects a light image based on the generated image data, onto the projection area 311 of the windshield 310. The configuration of the optical apparatus 10 is not directly related to the present invention, and thus the detailed configuration is not illustrated. For example, as described later, the optical apparatus 10 may include a laser light source and a scanning optical system in which laser light output from the laser light source is two-dimensionally scanned to generate an intermediate image, and the intermediate image is projected onto the windshield 310. The projection of the light image is not limited to a scanning method, and the light image may be projected onto the projection area 311 by a panel method.

The projection area 311 of the windshield 310 is formed of a transmission/reflection member that reflects some parts of the light components and transmits other parts of the light components. The light image rendered by the optical apparatus 10 is reflected by the projection area 311 and travels in the direction toward the occupant P. When the reflected light enters the pupils of the occupant P in the light paths indicated by the broken lines, the occupant P visually recognizes the image projected on the projection area 311 of the windshield 310. At this time, the occupant P perceives as if the light image enters his pupils from a virtual image position I, through the light paths indicated by the dotted lines. The displayed image is recognized as if the image exists at the virtual image position I.

The virtual image at the virtual image position I is displayed in a superimposed manner on the real environment in front of the automobile 300, for example, on the traveling path. In this sense, the formed image may be referred to as an augmented reality (AR) image.

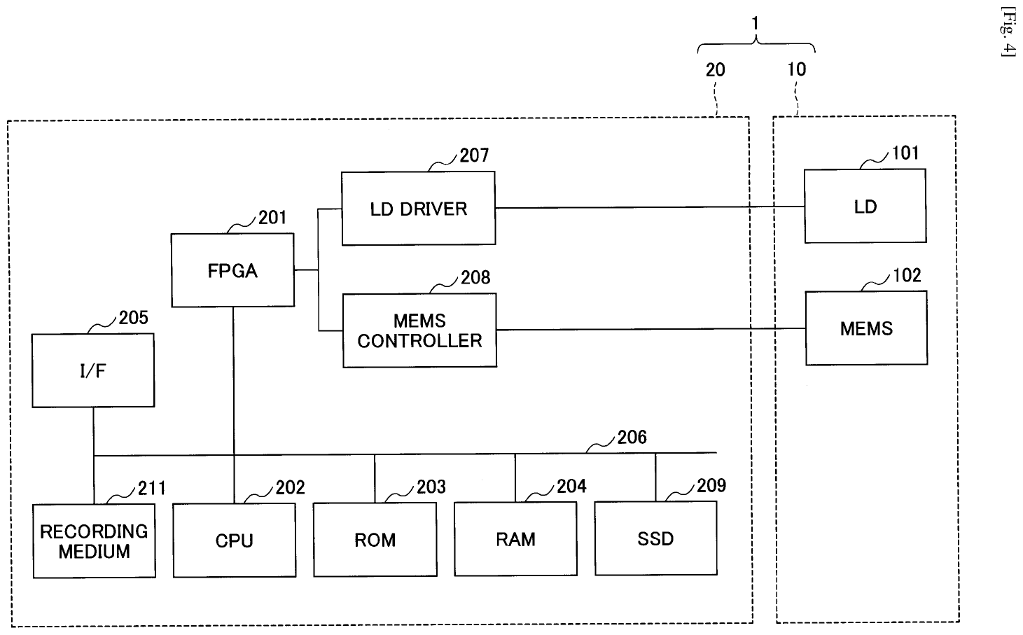

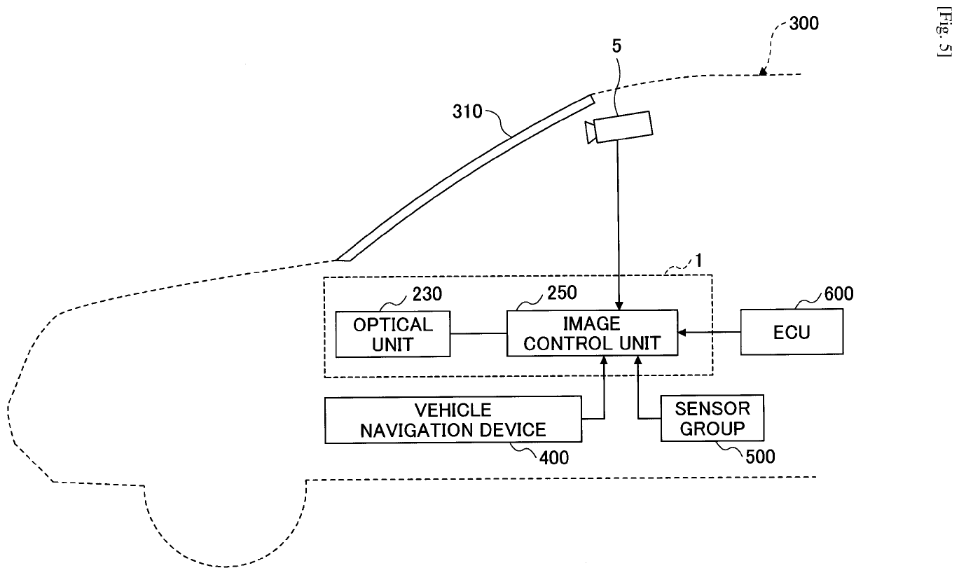

FIG. 3 is a diagram illustrating an arrangement example of the projection area 311. The projection area 311 is, for example, a relatively small area positioned slightly below the front position of the windshield 310 when viewed from the driver's seat. Line segments connecting the viewpoint of the occupant P and the virtual image position I are included in the range of the projection area 311, and the image enlarged at the virtual image position I is visually recognized.

The projection area 311 is not the same as a display area on which an image described later is displayed in a superimposed manner. The projection area 311 is an area on which the generated intermediate image is projected, while the display area is outside the projection area 311 and within the field of view of the occupant P, and is a predetermined area including the virtual image position I where the light image to be displayed in a superimposed manner is formed. The display area is set, for example, at a position several tens of meters ahead of the viewpoint of the occupant P.

The automobile 300 may be equipped with a camera 5 for acquiring information on the surrounding environment of the automobile 300; however, the camera 5 is not essential. The camera 5 captures an image of an external environment such as, for example, the front or the side of the automobile 300. The camera 5 is an example of a sensor for acquiring external information, and instead of the camera 5 or in combination with the camera 5, an ultrasonic radar or a laser radar, etc., may be used.

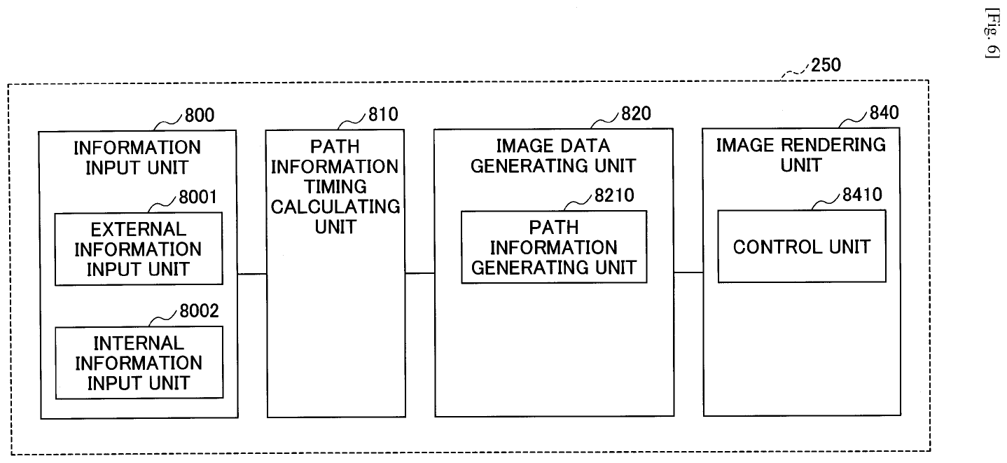

FIG. 4 is a hardware configuration example of the display apparatus 1 according to the embodiment. The optical apparatus 10 of the display apparatus 1 includes a laser diode (LD) 101 as a light source and a Micro Electro Mechanical System (MEMS) 102 as a light scanning device. The LD 101 includes, for example, laser elements that output light of red (R), green (G), and blue (B). The MEMS 102 two-dimensionally scans the laser light output from the LD 101 on a screen (not illustrated) to render an intermediate image. As the light scanning device, a polygon mirror or a galvanometer mirror, etc., may be used besides the MEMS.

The intermediate image formed on the screen, enters the projection area 311 via a mirror, etc., and is reflected in the direction of the occupant. The screen may be formed of a micro lens array or a micro mirror array, etc.

The image control apparatus 20 includes a field-programmable gate array (FPGA) 201, a central processing unit (CPU) 202, a read-only memory (ROM) 203, a random access memory (RAM) 204, an interface (hereinafter referred to as “I/F”) 205, a bus line 206, an LD driver 207, a MEMS controller 208, and a solid state drive (SSD) 209 as an auxiliary storage device. Furthermore, a recording medium 211 that can be detachably attached may be included.

The FPGA 201 controls the operation of the LD driver 207 and the MEMS controller 208. The LD driver 207 generates and outputs a drive signal for driving the LD 101 under the control of the FPGA 201. The drive signal controls the light emission timing of each of the laser elements that emit light of R, G, and B. The MEMS controller 208 generates and outputs a MEMS control signal under control of the FPGA 201, and controls the scan angle and scan timing of the MEMS 102. Instead of the FPGA 201, another logic device such as a programmable logic device (PLG) may be used.

The CPU 202 controls the overall image data processing of the display apparatus 1. The ROM 203 stores various programs including programs executed by the CPU 202 to control each function of the display apparatus 1. The ROM 203 may store various image objects used for displaying route images in a superimposed manner. The RAM 204 is used as a work area of the CPU 202.

The I/F 205 is an interface for communicating with an external controller, etc., and is connected to, for example, the camera 5, a vehicle navigation device, and various sensor devices via a Controller Area Network (CAN) of the automobile 300.

The display apparatus 1 can read and write information in the recording medium 211 via the I/F 205. An image processing program for implementing the processing in the display apparatus 1 may be provided by the recording medium 211. In this case, the image processing program is installed in the SSD 209 from the recording medium 211 via the I/F 205. The installation of the image processing program is not necessarily performed with the recording medium 211, and may be downloaded from another computer via a network. The SSD 209 stores the installed image processing program and also stores necessary files and data.

Examples of the recording medium 211 include portable recording media such as a flexible disk, a Compact Disk Read-Only Memory (CD-ROM), a digital versatile disc (DVD), a secure digital (SD) memory card, and a Universal Serial Bus (USB) memory. Furthermore, as the auxiliary storage device, a Hard Disk Drive (HDD) or a flash memory, etc., may be used instead of the SSD 209. The auxiliary storage device such as the SDD 209 and the recording medium 211 are both computer readable recording media.

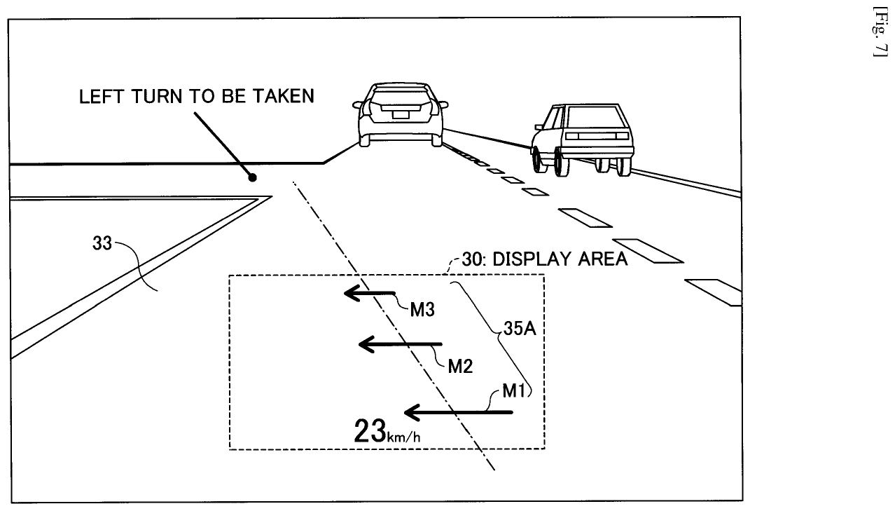

FIG. 5 is a schematic view illustrating a connection relationship between the display apparatus 1 of the embodiment and other electronic devices installed in the automobile 300. The display apparatus 1 includes an optical unit 230 and an image control unit 250. The optical unit 230 broadly corresponds to the optical apparatus 101; however, the FPGA 201, the LD driver 207, and the MEMS controller 208 may be included in the optical unit 230. The image control unit 250 is implemented by at least a part of the image control apparatus 20.

The display apparatus 1 is connected to an electronic device such as an electronic control unit (ECU) 600, a vehicle navigation device 400, and a sensor group 500 via the I/F 205 and the CAN. When the camera 5 is installed in the automobile 300, the camera 5 may also be connected to the display apparatus 1 via the I/F 205.

The display apparatus 1 acquires external information from the vehicle navigation device 400, the sensor group 500, and the camera 5, etc., and determines whether there is a factor causing a change in the route (that is, for example, a position where a left turn or a right turn is to be taken, etc.) ahead of the path on which the own vehicle is traveling. More specifically, it is determined whether there is a place where the route changes above (farther side) the upper end of the display area where the image is displayed in a superimposed manner. When a place where a route changes, such as an intersection or a branch road (for example, a position where a left turn or a right turn is to be taken, etc.), is detected above the upper end of the display area, that is, further ahead respect to the display area, the display apparatus 1 generates (or reads) image data of a planned path representing a route change, and outputs the image data. Specific examples of generation and output of an image of a planned path will be described with reference to FIG. 7 and onwards.

The sensor group 500 includes an angle sensor of a steering wheel, an angle sensor of a tire, an acceleration sensor, a gyro sensor, a laser radar device, and a brightness sensor, etc., and detects the behavior and the state of the automobile 300, the state of the surroundings of the automobile 300, and the distance to a vehicle traveling ahead, etc. The information obtained by the sensor group 500 is supplied to the image control unit 250, and at least a part of the sensor information is used to generate a planned path including the route change.

The vehicle navigation device 400 includes navigation information including a road map, global positioning system (GPS) information, traffic regulation information, and construction information of each road, etc. The image control unit 250 may use at least a part of the navigation information included in the vehicle navigation device 400 to determine the planned path. The generation of the planned path may be performed by the image control unit 250 or may be performed by the vehicle navigation device 400.

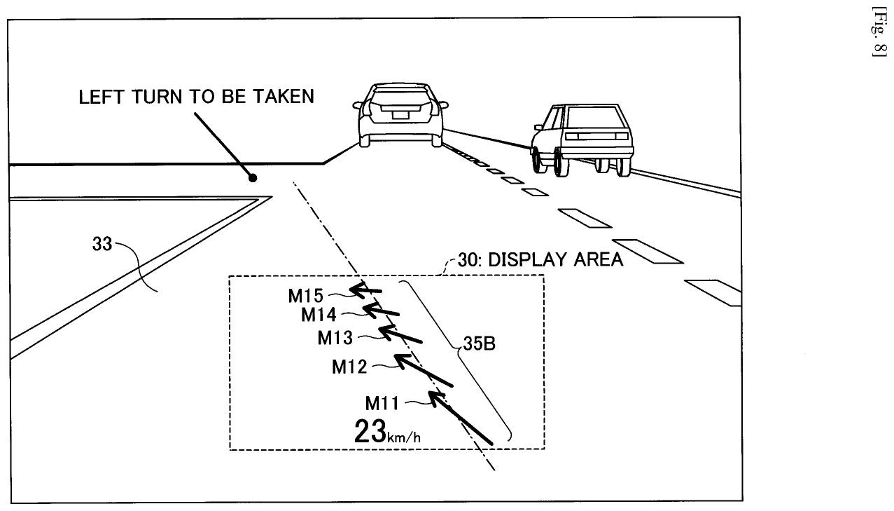

FIG. 6 is a functional block diagram of the image control unit 250. The image control unit 250 includes an information input unit 800, a path information timing calculating unit 810, an image data generating unit 820, and an image rendering unit 840. The information input unit 800 is implemented by the I/F 205, and inputs information from the vehicle navigation device 400, the sensor group 500, the ECU 600, and the camera 5, etc.

The information input unit 800 includes an external information input unit 8001 and an internal information input unit 8002. The internal information is information representing the state of the automobile 300 itself. The internal information input unit 8002 acquires information such as the present speed, the steering wheel angle, and the tire angle of the automobile 300, from the sensor group 500 and the ECU 600 via the CAN, etc.

The external information is information indicating an external situation of the automobile 300, other than the internal information. The external information input unit 8001 acquires navigation information, and map information, etc., from the vehicle navigation device 400. Alternatively, the external information input unit 8001 may acquire imaging information from the camera 5.

When the planned path is generated by the vehicle navigation device 400, the information input unit 800 may receive the planned path information generated from the vehicle navigation device 400.

The path information timing calculating unit 810 calculates the generation/output timing of the image data of the planned path including the change of progress, based on the external information and the internal information acquired by the information input unit 800. In general superimposed displays of a planned path, the AR image of the path indicating a change in the route such as a curve and a turn, etc., is displayed in a superimposed manner on the road, in a state where a curve and an intersection, etc., of the actual road is included in the display area. At a section where the change position of the route such as a curve or an intersection, is above the upper end of the display area, that is, at a section where the change position is positioned further ahead exceeding the display area as viewed from the occupant's viewpoint, the regular travelling path that does not include information such as a curve, is displayed in a superimposed manner.

On the other hand, in the present embodiment, at a section where the change position of the route is above the upper end of the display area, that is, further ahead of the display area as viewed from the occupant's viewpoint, the image of the planned path indicating the route change is displayed in a superimposed manner. This allows the occupant to recognize the planned path such as turning left or right, in advance.

The path information timing calculating unit 810 calculates how much earlier should the image data of the planned path representing the route change be output, based on the map information obtained from the vehicle navigation device 400 and the vehicle speed information obtained from the sensor group 500 or the ECU 600.

A path information generating unit 8210 of the image data generating unit 820 reads an object of the image data of the planned path representing the route change, from the ROM 204, at the timing calculated by the path information timing calculating unit 810, and processes the image data into a path image corresponding to the present position of the vehicle. That is, the path information generating unit 8210 generates image data, in which path guidance information indicating that there is a change in the route further ahead than the display area, can be displayed in a superimposed manner on the traveling road surface in a perspective manner, in a state where the actual position of the left or right turn, etc., is above the display area.

The image rendering unit 840 includes a control unit 8410, and controls the projection operation of the image by the optical apparatus 10, based on the image data generated by the image data generating unit 820. The image rendering unit 840 may be implemented by the FPGA 201, the LD driver 207, and the MEMS controller 208. Hereinafter, specific examples of the planned path and an auxiliary image will be described.

<Example of Path Guidance Information Indicating Route Change>

FIG. 7 is a diagram illustrating an example of path guidance information indicating a route change. In a fixed display area 30, path guidance marks M1 to M3 forming a path guidance pattern 35A, are displayed in a superimposed manner on the road surface of a traveling path 33. The left turn where the vehicle is to turn, is positioned above the upper end of the display area 30. The display apparatus 1 outputs a path guidance image indicating the presence of the route change in advance, before the left turn enters the display area 30, and displays the path guidance image in a superimposed manner on the traveling path 33.

The timing of outputting a path guidance image representing a route change is calculated by the image control unit 250 of the display apparatus 1, according to the type of road, the speed limit, and the speed of the own vehicle, etc.

In the example of FIG. 7, the path guidance marks M1 to M3 are displayed in a superimposed manner and in a perspective manner, by three parallel arrows extending in the direction in which a route change is planned to occur. The arrows of the path guidance marks M1 to M3 are displayed in a superimposed manner, such that the lengths of the arrows of the path guidance marks M1 to M3 become gradually shorter and the arrangement intervals between the arrows of the path guidance marks M1 to M3 become gradually narrower, toward the upper left obliquely where the left turn exists. Furthermore, the arrows of the path guidance marks M1 to M3 are arranged such that it can be intuitively recognized that a left turn is present at the end of the extended line of the arrangement of the path guidance marks M1 to M3 forming the path guidance pattern 35A (an extended line of at least part of information forming the pattern).

Note that the dashed-dotted line indicating the extended line of the arrangement of the path guidance marks M1 to M3 is rendered to facilitate the understanding of the present invention, and is not included in the object to be displayed in a superimposed manner.

The number, the length, and the display interval of the arrows indicating the left turn in the display area 30, are appropriately selected according to the traveling speed of the own vehicle. When travelling at a relatively high speed, the number of arrows may be reduced to widen the interval. When travelling at a relatively low speed, the number of arrows may be increased to narrow the interval. By displaying, in a superimposed manner, path guidance information representing a route change with an arrow pattern that is continuously changing, in a state where the actual left turn is above the display area 30 as viewed from the occupant, the occupant can recognize the planned route change while maintaining his or her line of sight directed ahead.

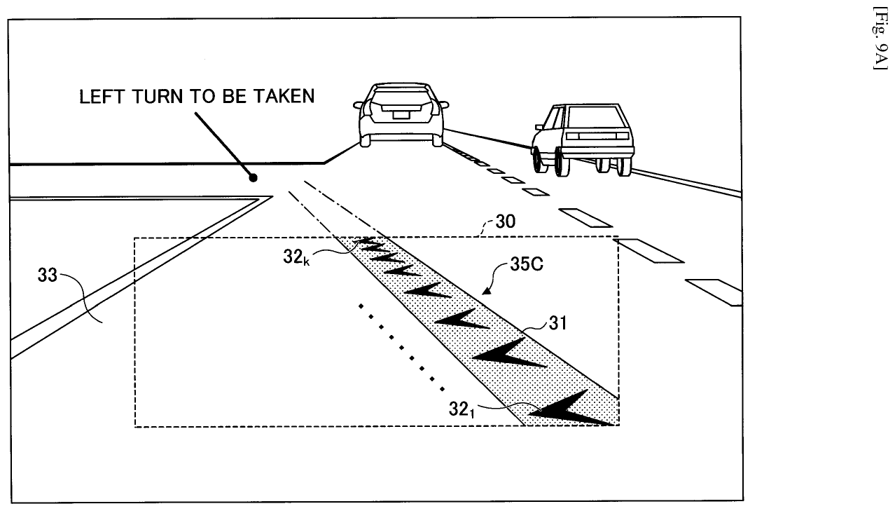

FIG. 8 illustrates another example of path guidance information representing a route change. In FIG. 7, the path guidance pattern 35A is formed with the path guidance marks M1 to M3 by parallel arrows having different lengths. As illustrated in FIG. 8, the angles of the arrows may be changed, toward the direction in which the route change is planned. Also in this case, the path guidance information is displayed in both a superimposed and a perspective manner, such that the position of the route change exists on the extended line of the arrangement of the path guidance marks M11 to M15 forming a path guidance pattern 35B.

The path guidance mark M11 is superimposed on the most front side of the traveling path 33, has the longest length, and has a large angle with respect to the horizontal axis of the display area 30. The length of each arrow decreases and the angle of each arrow with respect to the horizontal axis decreases, toward the upper side of the display area 30. The path guidance mark M15 closest to the upper end of the display area 30, is the arrow with the shortest length and that is almost horizontal.

Note that the dashed-dotted line indicating the extended line of the arrangement of the path guidance marks M11 to M15 is rendered to facilitate understanding of the present invention, and is not included in the object to be displayed in a superimposed manner.

When the left turn is above the upper end of the display area 30, the continuously changing path guidance marks M11 to M15 are output and displayed in a superimposed manner on the traveling path 33, whereby the occupant can recognize the change in the route in advance, and drive the vehicle with enough time.

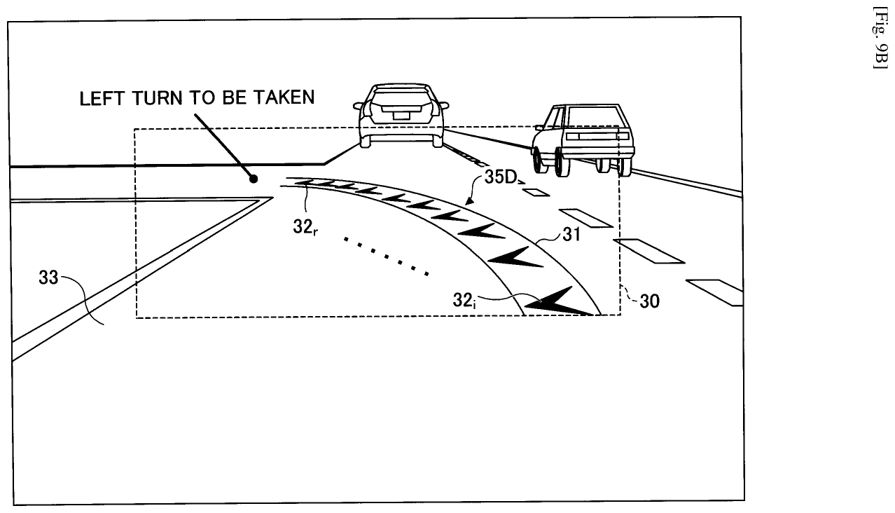

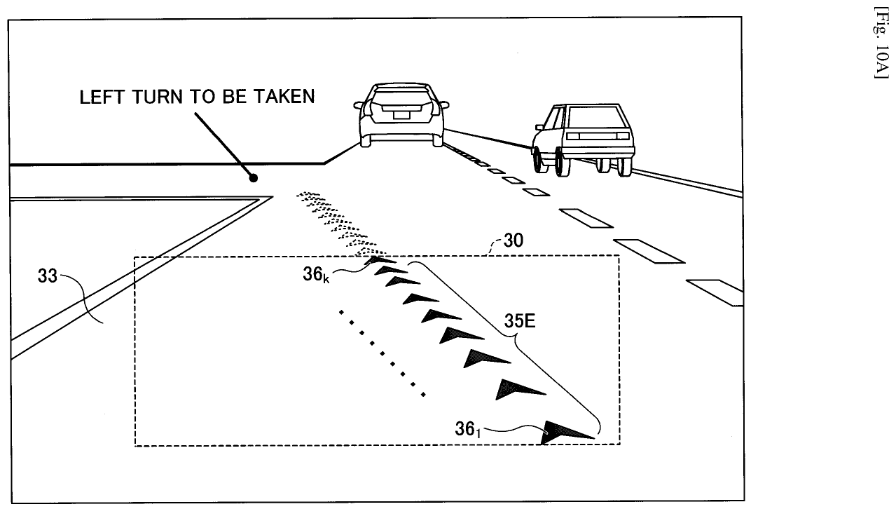

FIGS. 9A and 9B are diagrams illustrating another example of path guidance indicating a route change. A path guidance pattern 35C of FIG. 9A is formed of a strip-shaped pattern 31 and a plurality of arrows 32₁ to 32ₖ arranged in the strip-shaped pattern 31. The strip-shaped pattern 31 extends in a perspective manner from the lower right corner of the display area 30 toward the direction in which the left turn exists. The arrows 32₁ to 32ₖ are arranged continuously from the lower right corner of the display area 30, such that the shapes of the arrows gradually become smaller and the arrangement intervals gradually become narrower.

As illustrated in FIG. 9A, when the left turn is above the display area 30 as viewed from the occupant, the path guidance pattern 35C is displayed in a superimposed manner on the traveling path 33, such that the occupant can recognize the route change in advance while maintaining his or her line of sight directed ahead, and drive the vehicle with enough time.

As illustrated in FIG. 9B, when the left turn enters the display area 30, the pattern displayed in a superimposed manner may be changed as the own vehicle progresses, as in a path guidance pattern 35D. The strip-shaped pattern 31 curves to the left along the left turn in the display area 30. The plurality of arrows 32ᵢ to 32ᵣ are displayed in a superimposed manner in the strip-shaped pattern 31 such that the intervals between the arrows become gradually narrower and the arrows become gradually smaller toward the left turn.

By displaying, in a superimposed manner, the path guidance patterns 35B and 35D of FIGS. 9A and 9B on the traveling path 33, the occupant can predict, in advance, the route change existing ahead, and at the position where the route changes, the occupant can drive the vehicle while visually recognizing the driving trajectory of the own vehicle.

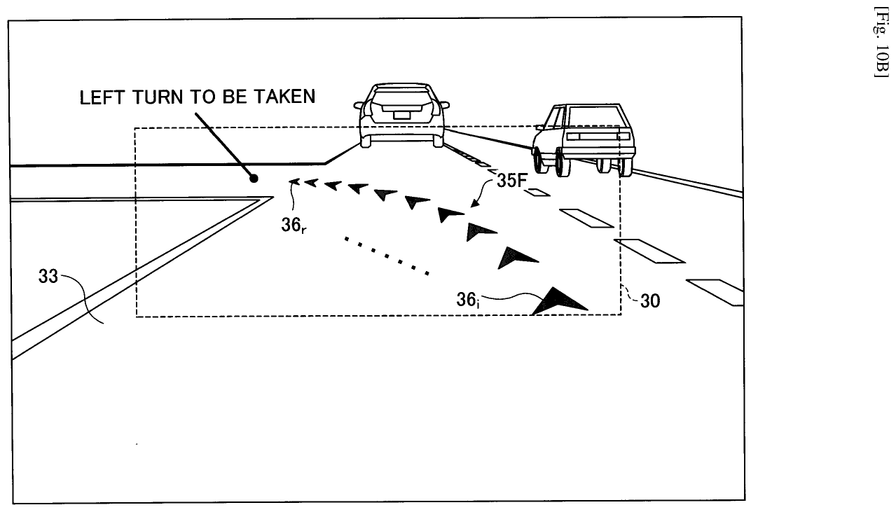

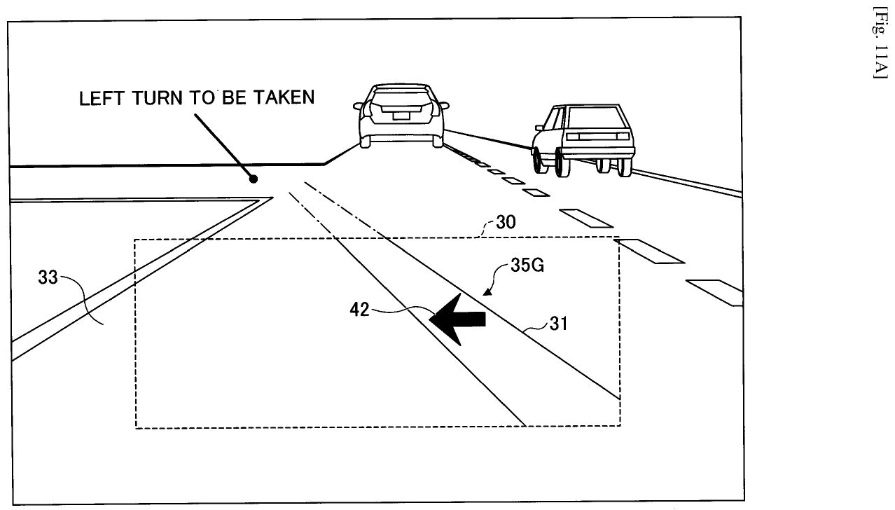

FIGS. 10A and 10B are diagrams illustrating still another example of path guidance representing a route change. As illustrated in FIG. 10A, when the left turn is above the display area 30, a path guidance pattern 35E indicating the presence of a left turn is displayed in a superimposed manner on the display area 30. The path guidance pattern 35E is formed by a series of arrows 36₁ to 36ₖ. The path guidance pattern 35E extends in a perspective manner from the lower right corner of the display area 30 toward the left turn. When viewed from the viewpoint of the occupant, the arrow 36₁ closest to the lower end of the display area 30 is displayed as the largest, and the size of the arrow 36 decreases and the intervals become narrower, toward the upper end of the display area 30. The path guidance pattern 35E is formed such that the actual left turn is positioned at the end of the extended line of the series of arrows 36₁ to 36ₖ.

By displaying, in a superimposed manner, the path guidance pattern 35E on the travelling path 33, the occupant can recognize the route change in advance while maintaining his or her line of sight directed ahead, and drive the vehicle with enough time.

As illustrated in FIG. 10B, when the left turn enters the display area 30, the pattern displayed in a superimposed manner may be changed as the own vehicle progresses, as in a path guidance pattern 35F. The arrangement of the arrows 36ᵢ to 36ᵣ curves to the left along the left turn in the display area 30.

By displaying, in a superimposed manner, the path guidance patterns 35E and 35F of FIGS. 10A and 10B on the traveling path 33, the occupant can predict, in advance, the route change existing ahead, and at the position where the route changes, the occupant can drive the vehicle while visually recognizing the driving trajectory of the own vehicle.

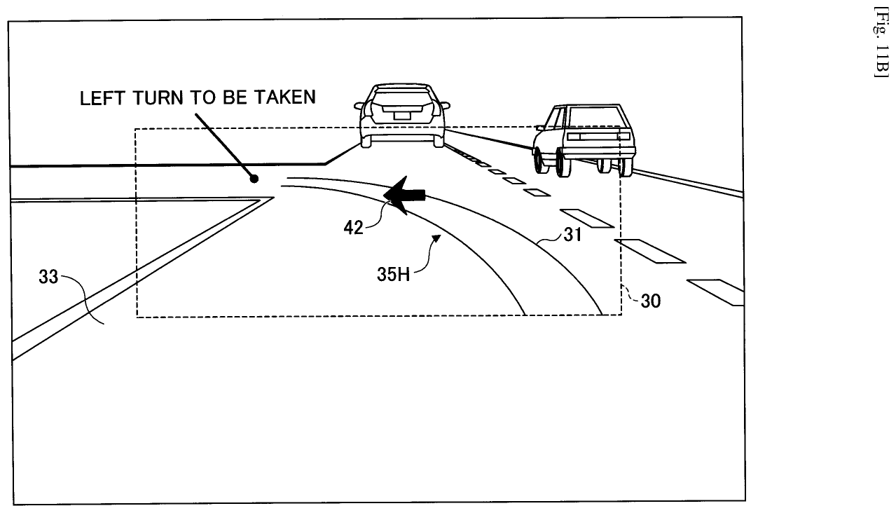

FIGS. 11A and 11B are diagrams illustrating another example of path guidance indicating a route change. A path guidance pattern 35G illustrated in FIG. 11A is formed of the strip-shaped pattern 31 and an arrow 42 arranged in the strip-shaped pattern 31. The strip-shaped pattern 31 extends from the lower right corner of the display area 30 in a perspective manner toward the left turn. The arrow 42 indicates the direction in which the route should be changed. The display position of the arrow 42 may be overlapping the strip-shaped pattern 31 or a line segment forming the strip-shaped pattern 31, as long as it is not difficult to see from the occupant.

As illustrated in FIG. 11A, when the left turn is above the display area 30 as viewed from the occupant, and the path guidance pattern 35G is displayed in a superimposed manner on the traveling path 33, the occupant can recognize the route change in advance while maintaining his or her line of sight directed ahead, and drive the vehicle with enough time.

As illustrated in FIG. 11B, when the left turn enters the display area 30, the pattern displayed in a superimposed manner may be changed as the own vehicle progresses, as in a path guidance pattern 35H in FIG. 11B. The strip-shaped pattern 31 curves to the left along the left turn in the display area 30, and the arrow 42 is displayed in a superimposed manner to indicate the left turn.

By displaying, in a superimposed manner, the path guidance patterns 35G and 35H of FIGS. 11A and 11B on the traveling path 33, the occupant can predict, in advance, the route change existing ahead, and at the position where the route changes, the occupant can drive the vehicle while visually recognizing the driving trajectory of the own vehicle.

In FIGS. 7 to 11B, the color, darkness, and the transparency, etc., of one or more arrows forming the path guidance marks or patterns may be varied. As the arrow is closer to the path change position, that is, as the arrow is farther away from the occupant's viewpoint, the color of the arrow may be displayed darker, or the arrow may be displayed with a conspicuous color such as red. An arrow near the lower end of the display area 30 is large in size and displayed in the foreground, and, therefore, the color of the arrow is made lighter and the transparency of the arrow is increased, so that the arrow does not obstruct the view of the occupant. Even in the case of using a single arrow 42 as illustrated in FIGS. 11A and 11B, the color and size, etc., of the arrow 42 may differ before entering verses after entering the path change position.

In the above-described example, the left turn that turns approximately 90 degrees has been described as an example; however, the present invention is not limited to the above application example, and the path guidance marks indicating the route change may be displayed in a superimposed manner before approaching the position where the route change occurs such as a right turn or Y-junction.

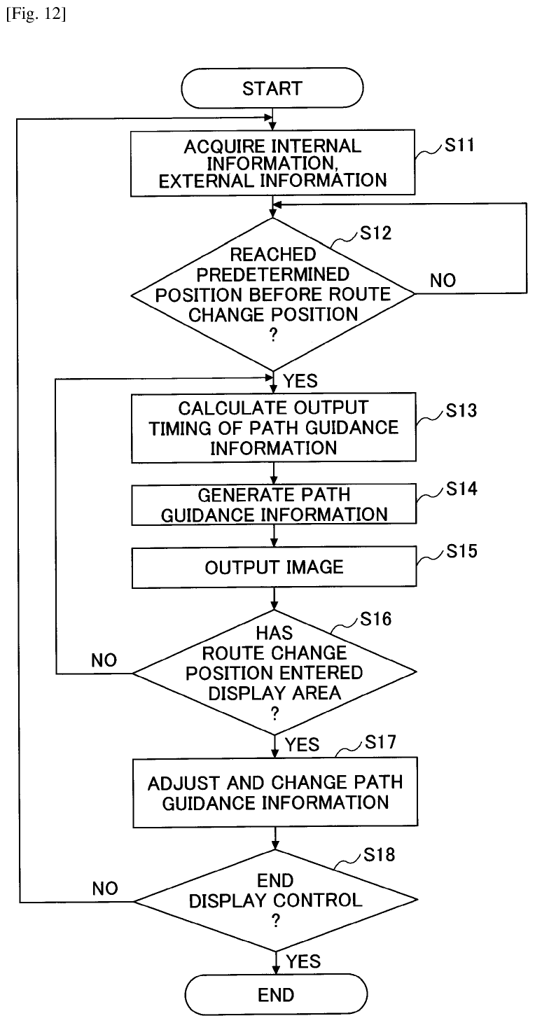

FIG. 12 is a flowchart of display control performed by the display apparatus 1. This control flow is performed by the image control unit 250 of the display apparatus 1.

The image control unit 250 acquires internal information and external information of the own vehicle (step S11). The internal information includes speed information, steering wheel angle information, tire angle information, and position information estimated by the own vehicle, etc., acquired from the sensor group 500 and the ECU 600. The external information is map information, imaging information, surrounding environment information, and distance measurement information, etc., acquired from the vehicle navigation device 400, the camera 5, the sensor group 500 (laser radar, etc.), and GPS, etc. When the planned path for traveling is generated by the vehicle navigation device 400, the planned path information may be acquired from the vehicle navigation device 400.

Based on the acquired information, the image control unit 250 determines whether the vehicle has reached a predetermined position before the position where there is a route change, for example, that is 100 meters to 200 meters before the position where there is a route change (step S12). When the vehicle has not reached a position before the route change position (NO in step S12), the route information may not be displayed, or the route information indicating the area ahead may be displayed. When the vehicle has reached a predetermined position before the route change position (YES in S12), the timing for outputting the path guidance information including the route change is calculated (step S13). The timing of outputting the path guidance information is calculated from the position where the route change occurs, and the present position and speed of the vehicle, etc. More specifically, the timing is calculated such that the path guidance indicating the route change is displayed in a superimposed manner on the traveling path, in a state where the position of the route change is above the display area 30 as viewed from the viewpoint of the occupant. Then, the path guidance information is generated (step S14) and output (step S15).

The calculation of the output timing (step S13) and the generation of the path guidance information (step S14) may be performed simultaneously or in reverse order.

After outputting the generated path guidance information, it may be determined whether the route change position is in the display area (step S16). As long as the route change position is not within the display area, steps S13 to S15 are repeated to display the path guidance information in a superimposed manner on the display area.

When the route change position enters the display area (YES in step S16), the pattern of the path guidance information may be adjusted according to the change in the route, as in FIG. 9B, 10B, or 11B (step S17).

Until the display control ends, steps S11 to S17 are repeated (NO in step S18). When the traveling of the vehicle is ended (when the engine is turned off) or when an instruction to turn off the display control is input, the display control is ended (YES in step S18), and the procedure is ended.

When the display control is executed by a program, the program for display control may be stored in the ROM 203 or the SSD 209 and the CPU 202 may read and execute the program. In this case, the CPU 202 executes at least the following procedures.

(a) Generate image data to be displayed, so as to be displayed in a superimposed manner on a predetermined position including at least a road surface in a direction along which the movable body moves as viewed from the occupant of the movable body.

(b) When the change of the route is included in the planned path generated in advance, and the route change position is farther away from the predetermined position as viewed from the occupant of the movable body, a pattern is displayed in a superimposed manner on the predetermined position.

Then, the pattern is displayed such that, when viewed from the occupant, the actual change position of the route is on the extended line of at least a part of the information forming the pattern.

By the configuration and method described above, even when the area of the display area 30 is limited and the change of the route cannot be displayed in a superimposed manner on the road surface, the path guidance indicating the presence of the route change is continuously output before the route change position, so that the occupant can anticipate a change in the route in advance.

For example, in the configuration and method of the present invention, when intersections or branch points are continuously positioned, and it is difficult to determine which corner is indicated by the “next corner” in the voice guidance of “please turn left at the next corner” by the navigation system, the present invention is particularly useful. The path guidance representing the route change is output from before the route change, and the path guidance information is displayed in a superimposed manner on the traveling path so that the actual corner to be turned is positioned on the extended line of the arrangement of marks or patterns arranged continuously. The occupant can turn at the correct position while maintaining his or her line of sight directed ahead, and drive the vehicle with enough time.

The present invention is not limited to the embodiments described above. For example, a path guidance pattern representing a route change can be any pattern other than arrows, such as an arrangement of continuous triangles, etc., that visually indicates the change in the route. Also, the color, intensity, and the transparency, etc., of the arranged marks can be changed in a stepwise manner, to increase the visibility of the route change.

As the optical apparatus 10, a panel method may be adopted instead of the laser scanning method. As the panel method, an imaging device such as a liquid crystal panel Digital Mirror Device (DMD) panel, a Vacuum Fluorescent Display (VFD), etc., may be used.

The projection area 311 of the windshield 310 may be provided with a combiner formed of a half-silvered mirror (half mirror, semitransparent mirror) or a hologram, etc. A light transmission/reflection type reflection film may be vapor-deposited on the surface of or between the layers of the windshield 310.

At least a part of each function of the display apparatus 1 may be implemented by cloud computing configured of one or more computers.

The image control apparatus, the display apparatus, the movable body, and the image control method are not limited to the specific embodiments described herein, and variations and modifications may be made without departing from the scope of the present invention.

The present application is based on and claims the benefit of priority of Japanese Priority Patent Application No. 2018-063761, filed on Mar. 29, 2018, and Japanese Priority Patent Application No. 2019-045258, filed on Mar. 12, 2019, the entire contents of which are hereby incorporated herein by reference.

### REFERENCE SIGNS LIST

1 display apparatus
5 camera
10 optical apparatus
20 image control apparatus
30 display area
32₁ to 32ₖ, 32ᵢ to 32ᵣ, 36₁ to 36ₖ, 36ᵢ to 36ᵣ,
35A to 35H path guidance pattern
230 optical unit
250 image control unit
300 automobile (movable body)
310 windshield
311 projection area
400 vehicle navigation device
500 sensor group
600 ECU
800 information input unit
810 path information timing calculating unit
820 image data generating unit
8210 path information generating unit
840 image rendering unit
8410 control unit
M1 to M3, M11 to M15 path guidance marks

1. An image control apparatus installed in a movable body, the image control apparatus comprising:
a controller configured to generate data of an image to be displayed so as to appear to be superimposed on a predetermined position including at least a road surface in a direction along which the movable body moves, as viewed from an occupant of the movable body, wherein
the controller generates a pattern to be displayed at the predetermined position, upon detecting that a change in a route is included in a planned path that is generated in advance, and that a change position where the route changes is further away than the predetermined position as viewed from the occupant of the movable body, and
the pattern is displayed in such a manner that an actual position of the change position of the route appears to be positioned on an extended line of at least part of information forming the pattern, as viewed from the occupant.

2. The image control apparatus according to claim 1, wherein the pattern includes a mark indicating at least a direction in which the route changes at the change position of the route.

3. The image control apparatus according to claim 1, wherein the pattern includes a plurality of marks.

4. The image control apparatus according to claim 3, wherein each of the plurality of marks indicates a direction of the change in the route.

5. The image control apparatus according to claim 3, wherein an arrangement interval between the plurality of marks becomes narrower, in accordance with proximity to the change position of the route.

6. The image control apparatus according to claim 3, wherein a size of the plurality of marks or a length of the plurality of marks in a predetermined direction decreases, in accordance with proximity to the change position of the route.

7. The image control apparatus according to claim 3, wherein the at least part of information forming the pattern is a center position of each of the plurality of marks.

8. The image control apparatus according to claim 3, wherein the at least part of information forming the pattern is an edge position of each of the plurality of marks.

9. The image control apparatus according to claim 1, wherein the pattern includes a line segment, and the at least part of information forming the pattern is the line segment.

10. The image control apparatus according to claim 1, wherein the controller generates the data of the image indicating the change position of the route instead of the pattern, upon detecting that the change position of the route enters a range where the image appears to be superimposed.

11. A display apparatus, comprising:
the image control apparatus according to claim 1; and
an optical apparatus configured to project a light image based on the data of the image, to a predetermined projection area of the movable body.

12. The movable body in which the display apparatus according to claim 11 is installed.

13. An image control method performed in a display apparatus installed in a movable body, the image control method comprising:
generating data of an image to be displayed so as to appear to be superimposed on a predetermined position including at least a road surface in a direction along which the movable body moves, as viewed from an occupant of the movable body; and
displaying, in a superimposed manner, a pattern at the predetermined position, upon detecting that a change in a route is included in a planned path that is generated in advance, and that a change position where the route changes is further away than the predetermined position as viewed from the occupant of the movable body, wherein
the pattern is displayed in such a manner that an actual position of the change position of the route appears to be positioned on an extended line of at least part of information forming the pattern, as viewed from the occupant.

14. A non-transitory computer-readable recording medium storing a program that causes a computer to execute a process performed in an image control apparatus installed in a movable body, the process comprising:
generating data of an image to be displayed so as to appear to be superimposed on a predetermined position including at least a road surface in a direction along which the movable body moves, as viewed from an occupant of the movable body, wherein the generating includes generating a pattern to be displayed at the predetermined position, upon detecting that a change in a route is included in a planned path that is generated in advance, and that a change position where the route changes is further away than the predetermined position as viewed from the occupant of the movable body, wherein
the pattern is displayed in such a manner that an actual position of the change position of the route appears to be positioned on an extended line of at least part of information forming the pattern, as viewed from the occupant.
